(19) United States
(12) Patent Application Publication
(10) Pub. No.: US 2014/0009946 A1
(43) Pub. Date: Jan. 9, 2014

(54) INJECTION-MOLDED LAMP BODY WITH CERAMIC COOLING APPARATUSES AND LEDS

(71) Applicants: Alexander Dohn, Memmelsdorf (DE); Roland Leneis, Marktredwitz (DE); Alfred Thimm, Wunsiedel (DE); Peter Stingl, Lauf (DE); Matthias Eschle, Wannweil (DE)

(72) Inventors: Alexander Dohn, Memmelsdorf (DE); Roland Leneis, Marktredwitz (DE); Alfred Thimm, Wunsiedel (DE); Peter Stingl, Lauf (DE); Matthias Eschle, Wannweil (DE)

(73) Assignee: CERAMTEC GMBH, Plochingen (DE)

(21) Appl. No.: 14/005,438

(22) PCT Filed: Mar. 27, 2012
(86) PCT No.: PCT/EP2012/055401

§ 371 Date: Sep. 16, 2013

(30) Foreign Application Priority Data
Mar. 29, 2011 (DE) 102011006339.0

(51) Int. Cl. F21V 29/00

(52) U.S. Cl. CPC F21V 29/004
USPC 362/373; 362/382

(57) ABSTRACT

In order to extend the life and reduce the fitting complexity involved, what is proposed is: the light-emitting unit comprises a plurality of individual identical cooling apparatus/light-emitting means modules (3), which are connected for form clusters (5), wherein each cooling apparatus/light-emitting means module (3) comprises a ceramic carrier body (1), which has, on one or more of its surfaces, sintered metallization regions (7), said metallization regions (9) forming a printed circuit board, to which one or more LEDs (2) is/are electrically conductively connected.

The invention relates to a light-emitting unit with LEDs for lamps.

Large-size lamps with neon tubes or light bulbs are also known to be used, for example, as building and street lighting. Light-emitting units with LEDs are also already available. A disadvantage is their short service life because the heat produced by the LEDs cannot be sufficiently dissipated so that thermal overload can occur. Moreover, each individual LED has to be fastened separately at its mounting site.

It is an object of the invention to improve a light-emitting unit with LEDs for lamps with regard to their service life and mounting complexity.

This object is achieved according to the invention by the features of the claim 1.

Due to the fact that the light-emitting unit consists of a plurality of individual identical cooling apparatus/light-emitting means modules that are connected to form clusters, wherein each cooling apparatus/light-emitting means module consists of a ceramic carrier body that has sintered metallization regions on one or more of its surfaces, and said metallization regions form a printed circuit board to which one or more LEDs is/are connected in an electrically conductive manner, a light-emitting unit is provided which, due to the metallization regions, exhibits good heat dissipation into the ceramics, resulting in a long service life. Moreover, the mounting complexity is significantly simplified because the entire light-emitting unit is composed only of identical cooling apparatus/light-emitting means modules that are connected to form clusters. Thus, it is not necessary to mount each cooling apparatus/light-emitting module separately.

In one embodiment, the ceramic carrier bodies are provided in one piece with ceramic heat-dissipating cooling elements, such as cooling ribs. Through these cooling elements, heat is dissipated. Each individual cooling apparatus/light-emitting means module is a carrier for one or more LEDs and includes at the same time a cooling device in the form of the cooling elements. The produced heat of the LEDs is transferred via the metallization regions into the ceramics of the carrier body and from there to the cooling elements. Each cooling apparatus/light-emitting means module is therefore self-sufficient with regard to heat dissipation.

In an alternative embodiment, the ceramic carrier bodies form a ceramic cooling box containing a cavity that can be cooled by a coolant, and the sintered metallization regions are arranged on the cooling box. This, among other things, is always an advantage in cases in which a liquid coolant is available which can be fed into the cavity of the cooling box.

In order to improve heat dissipation, the LEDs are connected to the metallization regions via an adhesive bond or, in a heat-conducting manner, using a solder (e.g., a low-melting SbSn solder).

Ease of mounting is preferably improved in that the individual cooling apparatus/light-emitting means modules are overmolded in a form-locking manner with plastic such as PE, PP or polyacrylate so as to form the clusters.

The individual clusters can be arranged on a molded plastic housing which then forms the light-emitting unit.

Preferably, the clusters have mounting positions such as, for example, bores, by which means the clusters can be easily mounted.

Thus, according to the invention, a light-emitting unit is proposed that consists of individual identically formed cooling apparatus/light-emitting means modules. On these modules, each of the LEDs is connected via an adhesive bond or, even better, in a heat conducting manner, using a solder (e.g., a low-melting SbSn solder). A plurality of these cooling apparatus/light-emitting means modules is connected to form a cluster, wherein each cluster has its mounting positions. One or even a plurality of clusters can be arranged in a fixed or interchangeable manner in a molded plastic housing.

In one embodiment, the cooling apparatus/light-emitting means modules consist of ceramic carrier bodies that are provided in one piece with ceramic heat-dissipating cooling elements, such as cooling ribs. Sintered metallization regions are arranged on the carrier body or on one or more of the surfaces thereof. These metallization regions form a printed circuit board onto which the LEDs are applied, for example, are soldered thereon.

Instead of ceramic heat-dissipating cooling elements, the ceramic carrier bodies can also form a ceramic cooling box that contains a cavity that is cooled by a coolant. In this case, the sintered metallization regions are arranged on the cooling box and form a printed circuit board onto which the LEDs are soldered, for example.

Assembling these cooling apparatus/light-emitting means modules so as to form clusters can preferably be carried out by injection molding, wherein the cooling apparatus/light-emitting means modules inserted in a tool are overmolded in a form-locking manner with a plastic material such as PE, PP or polyacrylate. The electrical supply lines can run inside or outside of the plastic material. Also, required controllers of the LEDs can be placed anywhere on the cooling apparatus/light-emitting means modules or within the plastic material.

Thus, a plurality of cooling apparatus/light-emitting means modules are connected to form a cluster and are arranged fixedly or interchangeably in a molded plastic housing, or are overmolded in a form-locking manner with plastic such as PE, PP or polyacrylate.

The entire construction of the light-emitting unit with LEDs, cooling apparatus and, optionally, a specifically designed plastic construction including, for example, a lamp cover, is simple and requires little mounting efforts. The cooling apparatus/light-emitting means modules in the clusters can point in different directions so as to illuminate a large solid angle. They can also be arranged spatially separated in a plastic frame in order to reduce the impression of high spot brightness. The construction of ensembles consisting of a plurality of modules is simplified. It is possible to form clusters that simplify the mechanical mounting efforts considerably.

The invention is further explained hereinafter with reference to the figures.

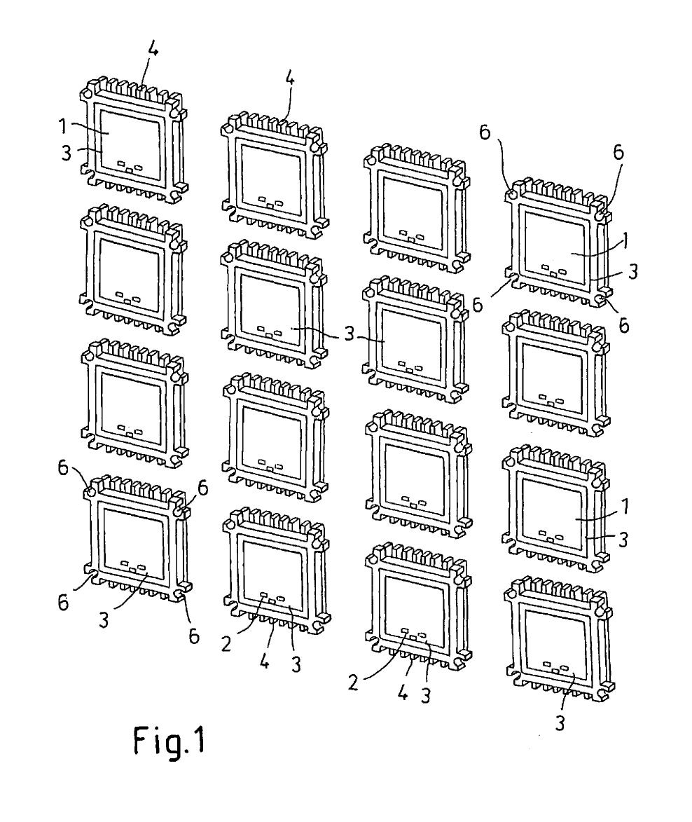

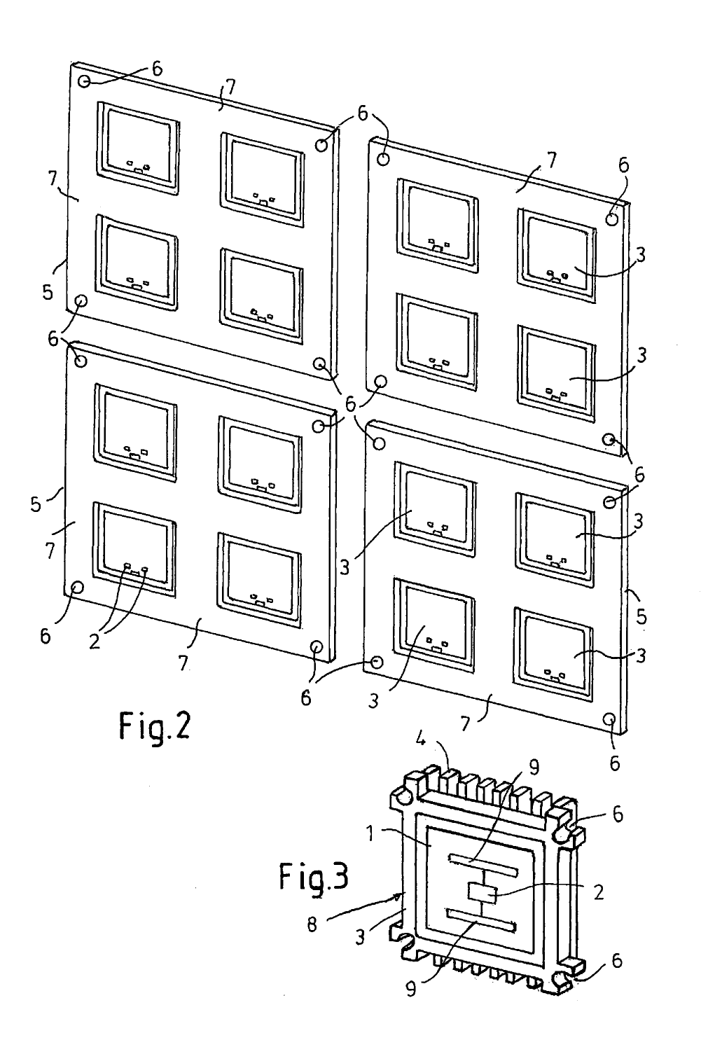

FIG. 1 shows 16 individual cooling apparatus/light-emitting means modules 3. Each cooling apparatus/light-emitting module 3 consists of a ceramic carrier body 1 that is provided in one piece with ceramic cooling elements 4, in the present case with cooling ribs. Sintered metallization regions are arranged on each of the cooling apparatus/light-emitting means modules 3 or on one or more of the surfaces thereof. These metallization regions form a printed circuit board onto which the LEDs 2 are soldered. To simplify matters, FIGS. 1 and 2 do not show the LED or LEDs, but only show the place where the LED is fastened. At this place there is also a metallization region which, however, is likewise not shown. For fastening, four mounting positions 6 are provided on each cooling apparatus/light-emitting means module 3.

FIG. 2 shows four clusters 5, each of which comprises four cooling apparatus/light-emitting means modules 3. The four cooling apparatus/light-emitting means modules 3 are either inserted into a frame 7 from plastic or are preferably overmolded with a plastic material. For mounting, four mounting positions 6 are arranged on each cluster 5, by means of which the four clusters 5 or the sixteen cooling apparatus/light-emitting means modules 3 can be connected to form a light-emitting unit or a lamp.

It is clearly shown that the embodiment according to FIG. 1 requires 16*4=64 mounting positions and that the embodiment according to FIG. 2 requires only 4*4=16 mounting positions.

FIG. 3 shows a single cooling apparatus/light-emitting means module 3 with a carrier body 1 that is connected in one piece with cooling elements 4, in the present case with cooling ribs. Arranged on the carrier body 1 are sintered metallization regions 9 to which an LED 2 is connected. The cooling apparatus/light-emitting means modules 3 are to be fastened via a frame 8 with mounting positions 6.

1. A light-emitting unit with LEDs (2) for lamps, characterized in that the light-emitting unit consists of a plurality of individual identical cooling apparatus/light-emitting means modules (3) that are connected to form clusters (5), wherein each cooling apparatus/light-emitting means module (3) consists of a ceramic carrier body (1) that has sintered metallization regions (9) on one or more of its surfaces, and said metallization regions (9) form a printed circuit board to which one or more LEDs (2) is/are connected in an electrically conductive manner.

2. The light-emitting unit according to claim 1, characterized in that the ceramic carrier bodies (1) are provided in one piece with ceramic heat-dissipating cooling elements (4) such as cooling ribs.

3. The light-emitting unit according to claim 1, characterized in that the ceramic carrier bodies (1) form a ceramic cooling box that contains a cavity that can be cooled by a coolant, and that the sintered metallization regions (9) are arranged on the cooling box.

4. The light-emitting unit according to any one of the claims 1 to 3, characterized in that the LEDs (2) are connected to the metallization regions (9) via an adhesive bond or, in a heat-conducting manner, using a solder (e.g., a low-melting SbSn solder).

5. The light-emitting unit according to any one of the claims 1 to 4, characterized in that for forming the clusters (5), the individual cooling apparatus/light-emitting means modules (3) are overmolded in a form-locking manner with plastic such as PE, PP or polyacrylate.

6. The light-emitting unit according to any one of the claims 1 to 5, characterized in that the clusters (5) are arranged in a molded plastic housing.
